(19) United States
(12) Patent Application Publication
(10) Pub. No.: US 2025/0319920 A1
(43) Pub. Date: Oct. 16, 2025

(54) Tailgate Shopping Cart Device

(71) Applicant: Diana Rose, Yorktown Heights, NY (US)

(72) Inventor: Diana Rose, Yorktown Heights, NY (US)

(21) Appl. No.: 18/925,124

(22) Filed: Oct. 24, 2024

Related U.S. Application Data
(60) Provisional application No. 63/632,770, filed on Apr. 11, 2024.

(51) Int. Cl. B62B 3/14

(52) U.S. Cl. CPC B62B 3/1484; B62B 3/1492

(57) ABSTRACT

A tailgate shopping cart device is provided. The device is comprised of all the features of existing shopping carts in addition to a front wall of a body that may rotate along a hinge to open the body such that items in the body of the device may be pushed out of the body rather than lifted. A top surface of a bottom wall of the body may be further comprised of at least one wheel from which the items in the device may be rolled across to allow for ease of pushing of the items from the device to a vehicle.

### CROSS-REFERENCE TO RELATED APPLICATION

The present application claims priority to, and the benefit of, U.S. Provisional Application No. 63/632,770, which was filed on Apr. 11, 2024, and is incorporated herein by reference in its entirety.

### FIELD OF THE INVENTION

The present invention relates generally to the field of shopping carts. More specifically, the present invention relates to a tailgate shopping cart device comprised of a front wall that may rotate along a hinge to open the body such that items in the body of the device may be pushed out of the body rather than lifted. A top surface of a bottom wall of the body may be further comprised of +at least one wheels+ from which the items in the device may be rolled across to allow for ease of pushing of the items from the device to a vehicle. Accordingly, the present disclosure makes specific reference thereto. Nonetheless, it is to be appreciated that aspects of the present invention are also equally applicable to other like applications, devices, and methods of manufacture.

### BACKGROUND

Individuals commonly use shopping carts, handheld baskets, or other similar objects to collect and transport items while shopping in retail stores, supermarkets, or other commercial establishments. Shopping carts, in particular, are widely used due to their large capacity, allowing customers to gather multiple items and navigate the store more conveniently. These carts are typically designed with wheels for mobility and often include a lower shelf for additional storage space. Shoppers frequently rely on these carts to carry items around the store, place them in the cart after selection, and then transport them to the checkout area. Once the transaction is complete, customers often use the carts to move their purchases to their vehicles in the parking lot.

However, many shopping carts have a deep, box-like structure, which, while maximizing storage, can present certain ergonomic challenges. Retrieving large, heavy, or bulky items from the bottom of the cart can be physically demanding. When it comes time to unload these items, particularly when transferring them into a vehicle, users must bend over or lift them at awkward angles. This can increase the risk of strain on the lower back and lead to discomfort, muscle fatigue, or, in some cases, serious back injuries. For individuals with preexisting conditions or limited physical strength, this lifting process can be even more challenging, exacerbating the risk of injury and making the task of shopping both cumbersome and potentially hazardous.

Therefore, there exists a long-felt need in the art for a device that eliminates the need for users to lift items out of a shopping cart when unloading the items into a vehicle. More specifically, there exists a long-felt need in the art for a tailgate shopping cart device in which items inside may simply slide out of rather than being lifted from when transporting the items into a vehicle. Furthermore, there exists a long-felt need in the art for a tailgate shopping cart device that can be easily operated by any shopper at any store.

The subject matter disclosed and claimed herein, in one embodiment thereof, comprises a tailgate shopping cart device. The device is designed to simplify the transfer of items from a retail store to a vehicle. The device comprises a rectangular body with side, rear, bottom, and front walls, the latter of which is hinged to rotate open, allowing items to be slid into a vehicle rather than lifted. The device includes wheels on the bottom surface to facilitate movement of items within the cart. A locking mechanism secures the front wall during transport, and a method for using the cart involves placing items inside, pushing them to a vehicle, unlocking the front wall, and sliding items directly into the vehicle.

In this manner, the tailgate shopping cart device of the present invention accomplishes all the forgoing objectives and provides a device that eliminates the need for customers to lift items from a shopping cart when unloading into a vehicle. More specifically, the tailgate shopping cart device allows items to be slid out from the device rather than being lifted when transporting the items from the device to another device or vehicle. Furthermore, the tailgate shopping cart device can easily be operated by any person and at any store.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tailgate shopping cart device primarily comprised of a body, at least one wheel, and a front wall. The device is designed to transport items from any retail store to a vehicle, allowing the items to be slid into the vehicle rather than lifted, such as from other styles of shopping carts.

The device preferably has all preferred features of existing shopping carts in addition to the front wall and wheel of the body. The device is comprised of a frame to support the device, at least one handle from which a user may push the device around a store, and wheels that allow the device to be pushed around a store easily.

The device is further comprised of a generally rectangular body such that the body is comprised of two side walls, a rear wall, a bottom wall, and a front wall. The front wall may be attached to a side wall via at least one hinge such that the front wall may rotate to open the body of the device. The front wall may be secured to the other side via a locking mechanism to keep the body closed. By opening the body, items inside the body may be removed by pushing the items along the top surface of the bottom wall of the body. The top surface of the bottom wall may further be comprised of at least one wheel that allows the items to be more easily pushed from the device and into a vehicle.

The present invention is also comprised of a method of using the device. First, a device is provided primarily comprised of a body, a front wall, and at least one wheel. Then, an item may be placed into the body of the device. Then, the device may be pushed up to an open trunk of a vehicle. Next, the front wall may be opened by disengaging the locking mechanism, allowing the front wall to rotate along the hinge. Then, the item may be pushed from the device into the vehicle along the wheel of the top surface of the bottom wall of the body.

Accordingly, the tailgate shopping cart device of the present invention is particularly advantageous as it provides a device that eliminates the need for customers to lift items from a shopping cart when unloading into a vehicle. More specifically, the tailgate shopping cart device can be easily operated by any person at any store to easily get purchased items from the store into a vehicle. Furthermore, the tailgate shopping cart device allows items to be slid out from the device rather than being lifted when transporting the items from the device to another object or vehicle. In this manner, the tailgate shopping cart device overcomes the limitations of existing shopping carts known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a tailgate shopping cart device of the present invention with the front wall open in accordance with the disclosed architecture;

FIG. 2 illustrates a perspective view of one potential embodiment of a tailgate shopping cart device of the present invention with the front wall closed in accordance with the disclosed architecture;

FIG. 3 illustrates an enhanced perspective view of a bottom wall of one potential embodiment of a tailgate shopping cart device of the present invention in accordance with the disclosed architecture; and

FIG. 4 illustrates a flowchart of a method of using one potential embodiment of a tailgate shopping cart device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that eliminates the need for customers to lift items out of a shopping cart when unloading the items into a vehicle. More specifically, there exists a long-felt need in the art for a tailgate shopping cart device in which items inside may simply slide out of rather than being lifted from when transporting the items into a vehicle. Furthermore, there exists a long-felt need in the art for a tailgate shopping cart device that can be easily operated by any shopper at any store.

The present invention, in one exemplary embodiment, is comprised of a tailgate shopping cart device. The device is primarily comprised of a body, at least one wheel, and a front wall. The device is designed to transport items from any retail store to a vehicle, allowing the items to be slid into the vehicle rather than lifted, such as from other styles of shopping carts.

More specifically, the device preferably has all the preferred features of existing shopping carts in addition to the front wall and wheel of the body. The device is comprised of a frame to support the device, at least one handle from which a user may push the device around a store, and wheels that allow the device to be pushed around a store easily.

The device is further comprised of a body from which any items may be placed into for easy transport around and from a store. The body is preferably made from a plastic or lightweight metal material typically used in existing shopping carts. The body, in the preferred embodiment, is rectangular in shape such that the body is comprised of two side walls, a rear wall, a bottom wall, and a front wall. The body of the device is open from the top to allow for ease of access to place items into the body of the device.

The front wall of the body may be attached to one of the side walls or the bottom wall in differing embodiments via at least one hinge, allowing the front wall to open and close. A locking mechanism may be activated to keep the front wall closed. The locking mechanism may be easily deactivated by the user to allow the front wall to open by rotating along the axis of the hinge. By opening the front wall, items stored in the body of the device may be rolled along a top surface of the bottom wall rather than lifted from the device. The top surface of the bottom wall may be further comprised of at least one wheel that allows objects to easily slide across the top surface of the bottom wall. The wheel may be attached to the bottom wall via an axle that allows the wheel to freely spin. In addition, an outside surface of the wheel may be made from any material that allows items in the body of the device to easily slide from the device and into a vehicle or other object.

The present invention is also comprised of a method of using the device. First, a device is provided primarily comprised of a body, a front wall, and at least one wheel. Then, an item may be placed into the body of the device. Then, the device may be pushed up to an open trunk of a vehicle. Next, the front wall may be opened by disengaging the locking mechanism, allowing the front wall to rotate along the hinge. Then, the item may be pushed from the device into the vehicle along the wheel of the top surface of the bottom wall of the body.

Accordingly, the tailgate shopping cart device of the present invention is particularly advantageous as it provides a device that eliminates the need for customers to lift items from a shopping cart when unloading into a vehicle. More specifically, the tailgate shopping cart device may allow items in the device to be easily slid rather than lifted from the device when transporting the items to a vehicle or other transportation vehicle. Furthermore, the tailgate shopping cart device can be operated easily by any person at any store to get items purchased from the store into a vehicle. In this manner, the tailgate shopping cart device overcomes the limitations of existing shopping carts known in the art.

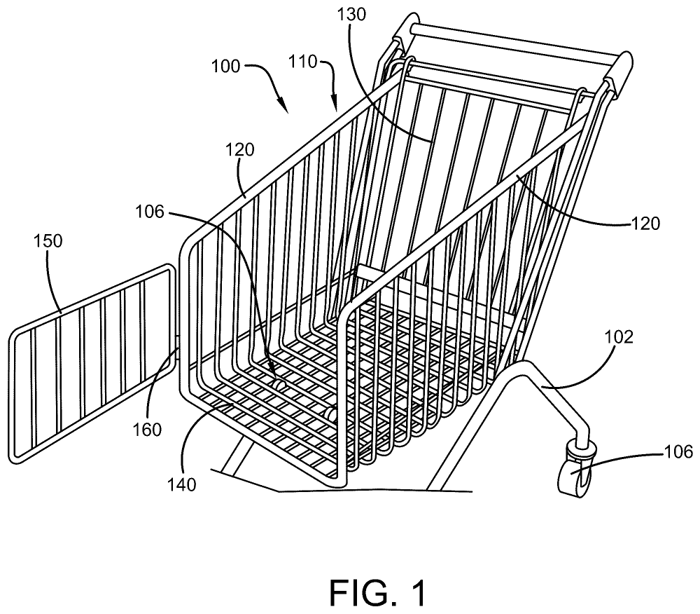

Referring initially to the drawings, FIG. 1 illustrates a perspective view of one potential embodiment of a tailgate shopping cart device 100 of the present invention with the front wall 150 open in accordance with the disclosed architecture. The device 100 is primarily comprised of a body 110, at least one wheel 144, and a front wall 150. The device 100 is designed to transport items from any retail store to a vehicle, allowing the items to be slid into the vehicle rather than lifted, such as from other styles of shopping carts.

The device 100 preferably has all commonly associated features of existing shopping carts, in addition to the novel features of the front wall 150 which will be described more fully below. The device 100 is comprised of a frame 102 from which the device 100 may be supported. The device 100 is further comprised of at least one handle 104 and at least one wheel 106 by which the device may be easily pushed throughout a store, to a vehicle from the store, and back to the store from the vehicle.

The device 100 may be further comprised of a body 110. The body 110 is preferably made from any material typically used to make existing shopping carts, such as a plastic or metal material, or a combination of both. The body 110 is generally rectangular in shape. In the preferred embodiment of the device 100, the body is comprised of two side walls 120, a rear wall 130, a bottom wall, and a front wall 150. The top of the body 110 is left open allowing for items to be easily placed into the body 110 of the device 100.

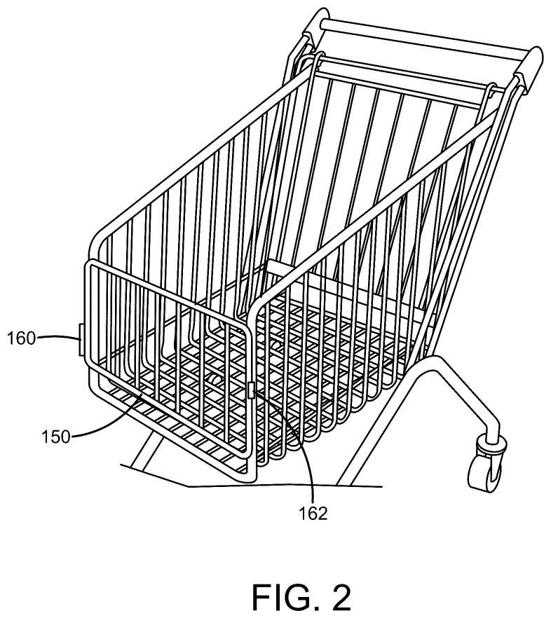

FIG. 2 illustrates a perspective view of one potential embodiment of a tailgate shopping cart device 100 of the present invention with the front wall 150 closed in accordance with the disclosed architecture. The front wall 150 of the body 110 may be attached to at least one of the side walls 120 and/or the bottom wall 140 via at least one hinge 160. The hinge 160 allows the front wall 150 to rotate outwards from the fixed position of a side wall 120 or bottom wall 140. The front wall 150 may remain in a closed position, i.e. attached to the bottom wall 140 and/or side wall 120, by engaging a locking mechanism 162 to secure the end of the front wall 150 that is not attached to the hinge 160 attached to another part of the body 110, such as but not limited to the side wall 120 and/or the bottom wall 140. The locking mechanism 162 may be comprised of any locking mechanism type such as but not limited to a clip, a latch, a button, or any other method for any style of locking mechanism 162 known in the art. In the preferred embodiment, the front wall 150 is attached to one side wall 120 via at least one hinge 160 and may be secured to the opposite side wall 120 via the locking mechanism 162. A second locking mechanism 162 may also be used to secure the front wall 150 to the body 110 when in an opened positioned.

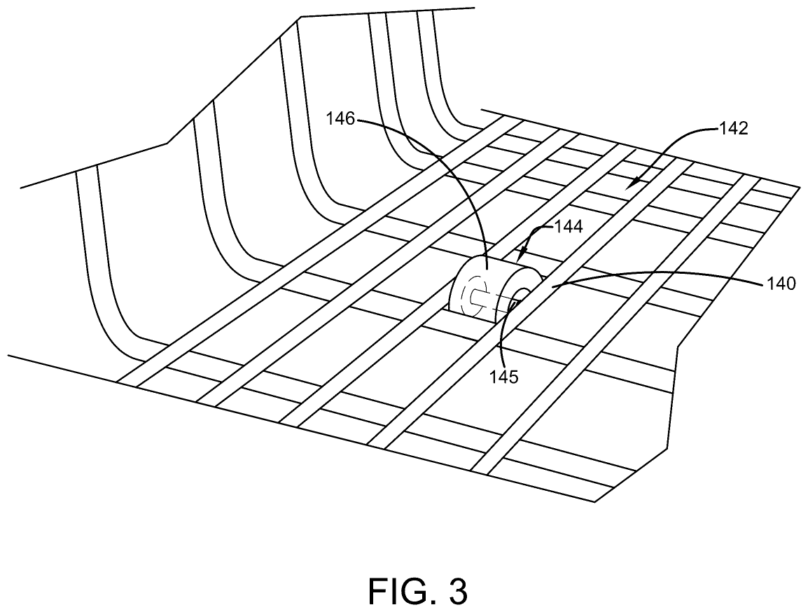

FIG. 3 illustrates an enhanced perspective view of a bottom wall 140 of one potential embodiment of a tailgate shopping cart device 100 of the present invention in accordance with the disclosed architecture. The bottom wall 140 is further comprised of a top surface 142 from which items may be placed onto when placed into the body 110 of the device 100. The top surface 142 may be further comprised of at least one wheel 144 (but preferably 6-8 wheels). The wheel 144 is preferably positioned parallel with the side walls 120 such that items inside the body 110 of the device 100 may be pushed across an outside surface 146 of the wheels 144 across the top surface 142. The wheels 144 may be any type of wheel such as ball bearing wheels, rubber wheels, air-filled wheels, etc. The wheels 144 may further rotate about an axle 145 such that the wheels 144 may freely rotate in the same direction (i.e., across the top surface 142) without stopping.

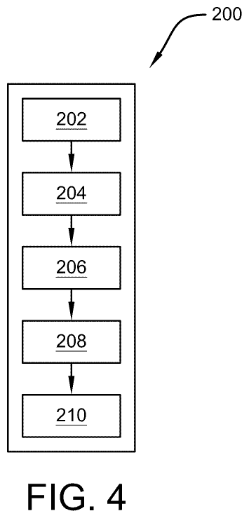

The present invention is also comprised of a method 200 of using the device 100, as seen in FIG. 4. First, a device 100 is provided primarily comprised of a body 110, a front wall 150, and at least one wheel 144 [Step 202]. Then, an item may be placed into the body 110 of the device 100 atop the wheel 144 [Step 204]. Then, the device 100 may be pushed up to an open trunk of a vehicle [Step 206]. Next, the front wall 150 may be opened by disengaging the locking mechanism 162, allowing the front wall 150 to rotate outwards along the axis of the hinge 160 [Step 208]. Then, the item may be pushed from the device 100 into the vehicle along the wheel 144 of the top surface 142 of the bottom wall 140 of the body 110 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tailgate shopping cart device” and “device” are interchangeable and refer to the tailgate shopping cart device 100 of the present invention.

Notwithstanding the forgoing, the tailgate shopping cart device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tailgate shopping cart device 100 as shown in the FIGS. are for illustrative purposes only, and that many other sizes and shapes of the tailgate shopping cart device 100 are well within the scope of the present disclosure. Although the dimensions of the tailgate shopping cart device 100 are important design parameters for user convenience, the tailgate shopping cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tailgate shopping cart device comprising:
a body comprised of a bottom wall, a first side wall, a second side wall, a rear wall, and a front wall attached to the first side wall or the second side wall via a hinge;
a wheel positioned on the bottom wall; and
a locking mechanism configured to secure the front wall to the first side wall, the second side wall, or the bottom wall.

2. The tailgate shopping cart device of claim 1, wherein the locking mechanism is comprised of a clip.

3. The tailgate shopping cart device of claim 1, wherein the locking mechanism is comprised of a latch.

4. The tailgate shopping cart device of claim 1, wherein the locking mechanism is comprised of a button.

5. The tailgate shopping cart device of claim 1, wherein the wheel is comprised of a ball bearing wheel.

6. The tailgate shopping cart device of claim 1, wherein the body is comprised of a handle.

7. A tailgate shopping cart device comprising:
a body having a top, a bottom wall, a first side wall, a second side wall, a rear wall, and a front wall, wherein the top of the body is open;
a wheel positioned on the bottom wall;
wherein the front wall is attached to the first side wall via a hinge, allowing the front wall to rotate outward; and
the front wall further comprising a locking mechanism to secure the front wall to the second side wall.

8. The tailgate shopping cart device of claim 7, wherein the wheel is comprised of an axle.

9. The tailgate shopping cart device of claim 8, wherein the wheel rotates 360 degrees around the axle.

10. The tailgate shopping cart device of claim 7, wherein the body is comprised of a secondary wheel.

11. The tailgate shopping cart device of claim 9, wherein the wheel rotates parallel to the first side wall and the second side wall.

12. The tailgate shopping cart device of claim 7, wherein the body is comprised of a rectangular shape.

13. A method of using a tailgate shopping cart device, the method comprising the following steps:
providing a tailgate shopping cart device comprised of a body comprised of a front wall, and a wheel;
placing an item into the body of the cart atop the wheel;
pushing the cart device to an open trunk of a vehicle;
disengaging a locking mechanism of the cart device and rotating the front wall outward by moving the front wall along a hinge; and
pushing the item from the body into the vehicle along the wheel on a bottom wall of the cart.

14. The method of using a tailgate shopping cart device of claim 13, wherein the front wall attaches to a side wall via the hinge.

15. The method of using a tailgate shopping cart device of claim 13, wherein the locking mechanism is comprised of a clip.

16. The method of using a tailgate shopping cart device of claim 13, wherein the locking mechanism is comprised of a button.

17. The method of using a tailgate shopping cart device of claim 13, wherein the locking mechanism is comprised of a clip.

18. The method of using a tailgate shopping cart device of claim 13, wherein the body is comprised of a secondary wheel.

19. The method of using a tailgate shopping cart device of claim 13, wherein the body is comprised of a handle.

20. The method of using a tailgate shopping cart device of claim 13, wherein the front wall and a first side wall of the body attach to the locking mechanism.
